(19) United States
(12) Patent Application Publication
(10) Pub. No.: US 2019/0093836 A1
(43) Pub. Date: Mar. 28, 2019

(54) ADJUSTABLE COMPACT RECESSED LIGHTING ASSEMBLY WITH HANGAR BARS

(71) Applicant: DMF, Inc., Carson, CA (US)

(72) Inventor: Michael D. Danesh, Carson, CA (US)

(21) Appl. No.: 16/200,393

(22) Filed: Nov. 26, 2018

Related U.S. Application Data
(63) Continuation of application No. 14/183,424, filed on Feb. 18, 2014, now Pat. No. 10,139,059.

(51) Int. Cl. F21S 8/02; F21V 21/04; F21Y 115/10; F21V 23/00

(52) U.S. Cl. CPC F21S 8/02; F21S 8/026; F21V 23/009; F21Y 2115/10; F21V 21/048

(57) ABSTRACT

A recessed lighting installation assembly includes a junction box having a cavity to contain a lighting system together with electrical wires from an electrical system of a building for connection to the lighting system. The assembly also includes a plurality of telescoping hangar bars coupled to the junction box to hold the junction box in a gap between a plurality of beams in the building. Each telescoping hangar bar is extendible and/or retractable to vary a length of the bar between the plurality of beams to meet the gap between the plurality of beams. A position of the junction box is adjustable along the length of each telescoping hangar bar between the plurality of beams. In one example, the recessed lighting installation assembly does not include a can, separate from the junction box, to contain the lighting system.

### CROSS-REFERENCE TO RELATED APPLICATIONS

This application is a continuation application (CON) of U.S. application Ser. No. 14/183,424, entitled “ADJUSTABLE COMPACT RECESSED LIGHTING ASSEMBLY WITH HANGAR BARS,” filed on Feb. 18, 2014.

### FIELD

An embodiment of the invention relates to recessed lighting systems that include a unified light source module and driver, coupled to a set of hangar bars.

### BACKGROUND

Recessed lighting systems are typically installed or mounted into an opening in a ceiling or a wall. Modern recessed lighting systems generally consist of a trim, a light source module, a driver circuit, a “can” or housing, a junction box, and a set of hangar bars. The driver is insulated from other portions and components of the recessed lighting system, including the light source module, through the use of insulation provided by the junction box while the light source module is housed in the can. The driver is electrically coupled to the light source module through the use of wires or other conduits so that the driver can power the light source module to emit light.

The junction box, the can, and other components of the recessed lighting system are attached to the hangar bars such that the hangar bars may support the components of the recessed lighting system in a wall or ceiling of a structure. For example the junction box may be attached to the hangar bars through the use of screws and bolts, which anchor the junction box and driver. In contrast, the combined can and light source module, which is electrically connected to the junction box and driver, is moveable.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 shows an exploded view of a recessed lighting system according to one embodiment.

FIG. 2 shows a side view of a combined junction box, light source module, driver, unified casting, and trim of the recessed lighting system according to one embodiment.

FIG. 3 shows top and side views of a junction box according to one embodiment.

FIG. 4 shows a perspective view of a hangar holder according to one embodiment.

FIG. 5 shows how the junction box and hangar holders can be moved and positioned horizontally along hangar bars and vertically along the axis Y according to one embodiment.

FIG. 6 shows a perspective view of a screwdriver bending a tab of a hangar holder to lock the hangar holder in a position along the hangar bars according to one embodiment.

FIG. 7 shows a perspective view of a hangar holder according to another embodiment.

### DETAILED DESCRIPTION

Several embodiments are described with reference to the appended drawings are now explained. While numerous details are set forth, it is understood that some embodiments of the invention may be practiced without these details. In other instances, well-known circuits, structures, and techniques have not been shown in detail so as not to obscure the understanding of this description.

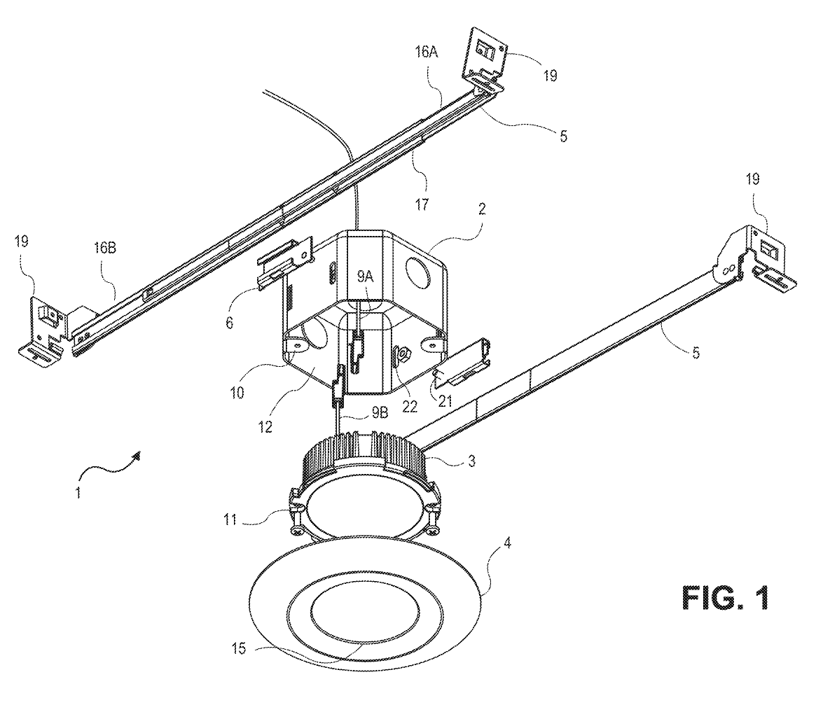

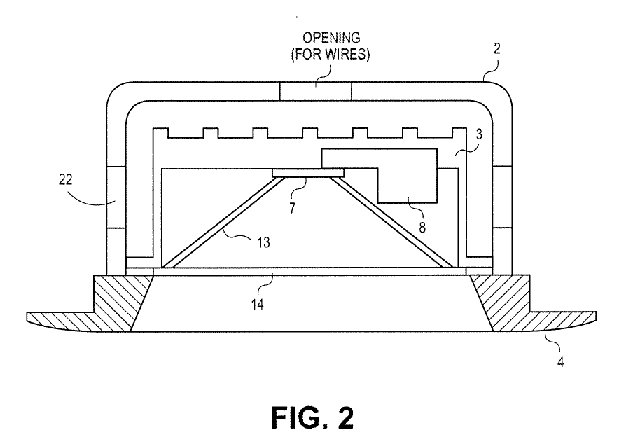

FIG. 1 shows an exploded view of a recessed lighting system 1. The recessed lighting system 1 may include a junction box 2, a unified casting 3, a trim 4, a set of hangar bars 5, and a set of hangar holders 6. In some embodiments, the unified casting 3 may include a light source module 7 and a driver 8 in a single compact unit as shown in FIG. 2. As will be described in further detail below, the recessed lighting system 1 provides a more compact and cost effective design that allows the unified casting 3 to be moved and adjusted while complying with various building and safety codes/regulations. Each of the elements of the recessed lighting system 1 will be explained by way of example below.

The junction box 2 is a structure that separates the inner components of the recessed lighting system 1, including electrical wires/cables, from the items inside a ceiling or crawl space (e.g., insulation) in which the junction box 2 has been installed. In one embodiment, the junction box 2 may be a single or double gang box with a fire rating of up to two hours as described in the National Electrical Code (NEC) and by the Underwriters Laboratories (UL). The junction box 2 may receive electrical wires 9A from an electrical system (e.g., 120 VAC or 277 VAC) within a building or structure in which the recessed lighting system 1 is installed. The electrical wires 9A from the structure may be connected to corresponding wires 9B of the unified casting 3, as will be described in greater detail below.

In one embodiment, the junction box 2 may include one or more tabs 10 for coupling the junction box 2 to the casting 3. The tabs 10 may be any device/component for receiving corresponding elements 11 of the casting 3 to firmly hold the weight of the unified casting 3, including the light source module 7 and the driver 8 which may be contained in the casting 3. The trim 4 may also be attached to the junction box 2 to hide at least the periphery of the junction box from view. As shown in FIG. 1, the tabs 10 include holes for receiving screws or bolts; however, in other embodiments the tabs 10 may facilitate a twist-and-lock friction connection with corresponding elements 11 of the casting 3 and without the use of separate tools or other devices. In still other embodiments, friction or tension clips 24 may be utilized to retain the casting 3 inside the junction box 2.

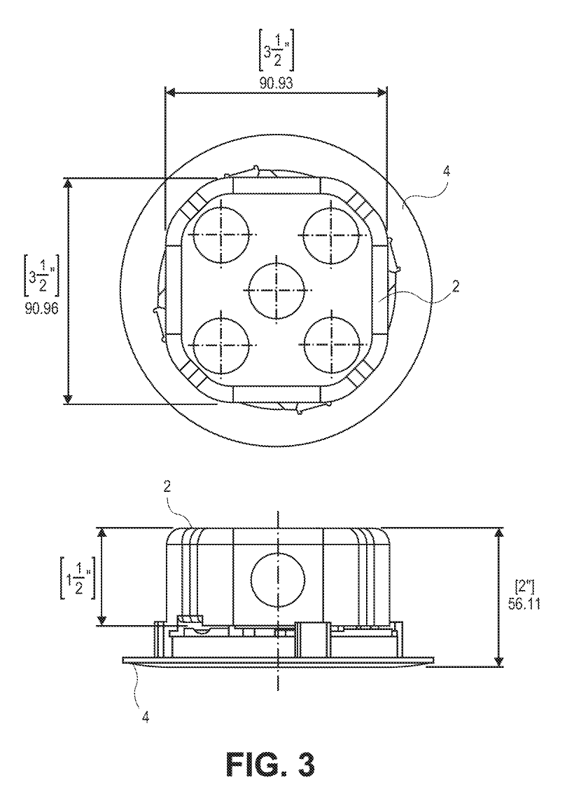

In one embodiment, the junction box 2 acts as a heat barrier to block heat emitted by the light source module 7 and the driver 8 (See FIG. 2) from reaching possibly flammable items inside a ceiling or crawl space. Accordingly, the compact design may provide fire rating up to two hours. In these embodiments, the junction box 2 may be formed of metals, polymers, metal alloys, and/or other heat insulating materials. As shown in FIG. 1, the junction box 2 may be a polyhedron that defines a cavity 12 therein. However, in other embodiments, the side wall of the junction box 2 may be curved and have any suitable shape, including an ellipsoid, cone, or cylinder, so that the box is still capable of receiving therein the casting 3. The cavity 12 that is formed in the junction box 2 is larger than the casting 3 such that the casting 3 easily fits into the cavity 12, preferably without coming into direct contact with the side walls of the junction box 2. However, in other embodiments, the casting 3 may be sized to come into direct contact with the side walls of the junction box 2. The size of the cavity 12 may be pursuant to popular industry specifications for junction boxes and in compliance with any applicable building and safety codes/regulations. For example, as shown in the top and side views of FIG. 3, the junction box 2 may have a length of 3½ inches, a width of 3½ inches and a depth of 1½ inches. When coupled together, the combined junction box 2, casting 3, and trim 4 may have a height/depth of about 2 inches, e.g., no more than 3 inches. In one embodiment, the combined junction box 2, casting 3, and trim 4 may have a height/depth between 2-3 inches.

As shown in FIG. 1, the casting 3 may be a cylindrical structure; however, in other embodiments, the casting 3 may be any suitable shape, including an ellipsoid, cone, or polyhedron that is capable of housing the light source module 7 and the driver 8.

In one embodiment, the electrical wires 9A received by the junction box 2 from the electrical system of a building or structure may be coupled to the electrical wires 9B of the casting 3. As shown, the electrical wires 9A and 9B are connected together through the use of interlocking connectors that may be contained within the box 2 (together with the casting 3). However, in other embodiments, the electrical wires 9A may be coupled to the electrical wires 9B through the use of electrical caps or other devices, and that may be kept outside the box 2 (while the casting 3 is retained inside). The electrical wires 9B of the casting 3 may terminate in a connection with the driver 8 installed within the casting 3. When the wires 9A and 9B are connected, electricity may pass from the electrical system of the building or structure to the driver 8 to enable the driver 8 to power the light source module 7.

In one embodiment, the casting 3 includes one or more heat sinks to dissipate heat generated by the light source module 7 and/or the driver 8. Although the heat sinks are shown as passive components that cool the combined casting 3, light source module 7, and driver 8 by dissipating heat into the surrounding air, active heat sinks (e.g., fans) may also be used. In one embodiment, the heat sinks are defined by a set of fins surrounding the casting 3. The heat sinks may be composed of any thermally conductive material. For example, the heat sinks may be made of aluminium alloys, copper, copper-tungsten pseudoalloy, AlSiC (silicon carbide in aluminium matrix), Dymalloy (diamond in copper-silver alloy matrix), E-Material (beryllium oxide in beryllium matrix), and/or thermally conductive plastics or ceramics.

As described above, the recessed lighting system 1 may include the driver 8. The driver 8 is an electronic circuit or device that supplies and/or regulates electrical energy to the light source module 7 and thus powers the light source module 7 to emit light. The driver 8 may be any type of power supply, including power supplies that deliver an alternating current (AC) or a direct current (DC) voltage to the light source module 7. Upon receiving electricity, the driver 8 may regulate current or voltage to supply a stable voltage or current within the operating parameters of the light source module 7. The driver 8 receives an input current from the electrical system of the building or structure in which the recessed lighting system 1 is installed and may drop the voltage of the input current to an acceptable level for the light source module 3 (e.g., from 120V-240V to 36V-48V). The driver 8 may transfer electricity to the light source module 7 through an electrical connector. For example, the driver 8 may deliver electricity to the light source module 7 through an electrical cable coupled between the light source module 7 and the driver 8 through removable or permanent connectors or soldered leads originating from the driver 8. Although shown with magnetic transformer 18, the driver 8 may include additional or alternative circuitry for voltage conversion and for regulating the input current or voltage to the light source module 7.

The light source module 7 may be any electro-optical device or combination of devices for emitting light. For example, the light source module 7 may have as a single light source a light emitting diode (LED), organic light-emitting diode (OLED), or polymer light-emitting diode (PLED). In some embodiments, the light source module 7 may have multiple light sources (e.g., LEDs, OLEDs, and/or PLEDs). The light source module 7 receives electricity from the driver 8, as described above, such that the light source module 7 may emit a controlled beam of light into a room or surrounding area. The driver 8 is designed to ensure that the appropriate voltage and current are fed to the light source module 7 to enable the emission of light by the one or more light sources within the light source module 7.

The light source module 7 and the driver 8 may be coupled to the casting 3 using any connecting mechanism, including screws, resins, clips, or clamps. For example, in one embodiment, the light source module 7 and the driver 8 may be coupled to the casting 3 using friction or tension clips.

In some embodiments, the recessed lighting system 1 may include a reflector 13 (See FIG. 2). The reflector 13 may surround the light source module 7, or just a light source of the light source module 7, to adjust the way light emitted by the light source module 7 is focused inside a room or surrounding area. In one embodiment, the reflector 13 surrounds the light source module 7 and also separates the light source module 7 from the driver 8. This separation allows light from the light source module 7 to be emitted into a room or surrounding area, while shielding the driver 8 from being exposed to the room or surrounding area. For example, in one embodiment, the reflector 13 and the casting 3 may together create a sealed structure to shield the driver 8 from the outside environment and the light source module 7. By shielding the driver 8 from the outside environment, the reflector 13 might reduce the risk of fire or other dangers and ensures the recessed lighting system 1 complies with building and safety codes/regulations. The reflector 13 may be formed of any fire retardant material, including steel, aluminum, metal alloys, calcium silicate, and other similar materials.

Although shown as frusto conical, the reflector 13 may be formed in any shape that may direct and/or focus light. For example, the reflector 13 may be parabolic or spherical. In one embodiment, the front surface of the reflector 13 may be coated with a reflecting material or include one or more reflecting elements that assists in the adjustment of light emitted by the light source module 7. For example, the reflector 13 may be coated with a shiny enamel or include one or more mirrors or retroreflectors or a microcellular polyethylene terephthalate (MCPET) material to adjust the focus of light emitted by the light module 7. In other embodiments, the reflector 13 may include various other optic elements to assist in the focusing of light emitted by the light source module 7.

In one embodiment, the recessed lighting system 1 may include a lens 14 (See FIG. 2). The lens 14 may be formed to converge or diverge light emitted by the light source module 7. The lens 14 may be a simple lens comprised of a single optical element or a compound lens comprised of an array of simple lenses (elements) with a common axis. In one embodiment, the lens 14 also provides a protective barrier for the light source module 7 and shields the light source module 7 from moisture or inclement weather. The lens 14 may also assist in the diffusion of light and increase the uniformity of light over the surface of the recessed lighting system 1. The lens 14 may be made of any at least partially transparent material, including glass and hard plastics. In one embodiment, the lens 14 and the reflector 13 are contained in a single indivisible unit to work in conjunction to focus and adjust light emitted by the light source module 7. In other embodiments, the lens 14 and the reflector 13 may be separate, divisible elements.

In one embodiment, the recessed lighting system 1 may include a trim 4. The trim 4 serves the primary purpose of covering the exposed edge of the ceiling or wall where a hole is formed in which the recessed lighting system 1 resides while still allowing light from the light source module 3 to be emitted into a room through an aperture 15. In doing so, the trim 4 helps the recessed lighting system 1 appear seamlessly integrated into the ceiling or wall. In one embodiment, the trim 4 is to be attached to the casting 3 while in other embodiments the trim 4 is to be attached to the junction box 2. The trim 4 may couple to the casting 3 and/or the junction box 2 using any connecting mechanism, including resins, clips, screws, bolts, or clamps. In one embodiment, the trim 4 may include grooves and/or slots to couple to corresponding grooves and/or slots of the casting 3 and/or the junction box 2 using a twist-and-lock friction connection and without the use of separate tools or other devices.

In one embodiment, different diameter trims 4 may be capable of being coupled to the casting 3 and/or the junction box 2. The size and design of the trims 4 may depend on the size of the hole in which the recessed lighting system 1 has been fitted to conceal the exposed wall or ceiling edge that defines the hole. As well, the trim 4 may need to meet the aesthetic demands of the consumer. The trim 4 may be made of aluminum plastic polymers, alloys, copper, copper-tungsten pseudoalloy, AlSiC (silicon carbide in aluminum matrix), Dymalloy (diamond in copper-silver alloy matrix), and E-Material (beryllium oxide in beryllium matrix).

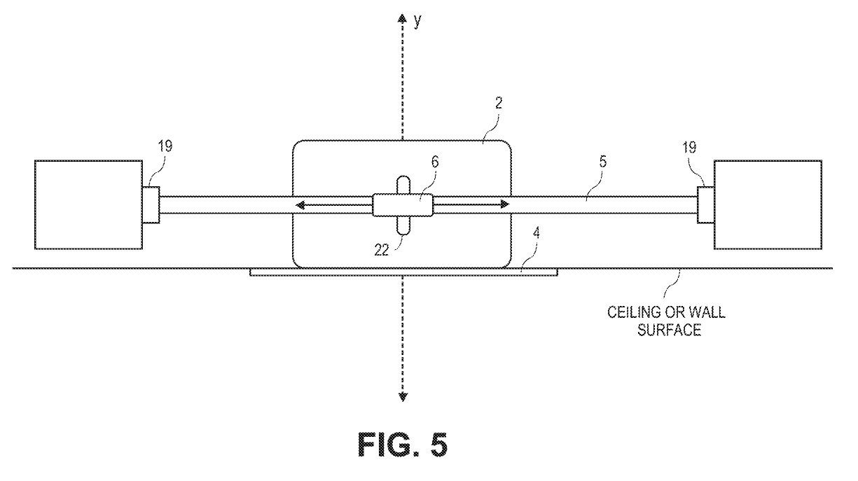

In one embodiment, the recessed lighting system 1 may include a set of hangar bars 5 as shown in FIG. 1. The hangar bars 5 may be rigid, elongated members that are connected between adjacent joists and/or beams in the walls or ceilings of a structure (See FIG. 5). In one embodiment, each of the hangar bars 5 may be telescoping such that each hangar bar 5 may be extended or retracted to meet the gap between the joists and/or beams. In this embodiment, each hangar bar 5 may include an inner bar element 16A and an outer bar element 16B. The inner bar element 16A may be inserted and then held inside a railing structure 17 formed on the outer bar element 16B. In this configuration, the inner bar element 16A may slide in relation to the outer bar element 16B to vary the total length of each hangar bar 5. In one embodiment, the railing structure 17 within the outer bar element 16B may be formed by a set of guides. The guides may be bent pieces of the outer bar element 16B or tabs that are coupled to the outer bar element 16B. In this fashion, the railing structure 17 forms a channel for the inner bar element 16A.

In one embodiment, each of the hangar bars 5 may include a set of mounting blocks 19. The mounting blocks 19 may be used to couple the hangar bars 5 to the joists and/or beams in the walls or ceilings of a structure. For example, as shown in FIG. 1, the mounting blocks 19 may include holes for receiving screws and/or nails or other fasteners that enable the hangar bars 5 to be securely attached to a building structure. Although shown in FIG. 1 and described above in relation to holes and screws, in other embodiments, other mechanisms of attachment may be used in conjunction with the mounting blocks 19, including resins, clips, or clamps to attached the bars 5 to the building structure. In one embodiment, the mounting blocks 19 may be integrated in one indivisible structure along with the inner bar element 16A and the outer bar element 16B, while in other embodiments, as shown in FIG. 1, the mounting blocks 19 may be coupled to the inner bar element 16A and the outer bar element 16B through the use of one or more attachment mechanisms (e.g., screws, bolts, resins, clips, or clamps). Using the above telescoping and mounting features, the recessed lighting system 1 may be installed in almost all the 2″×2″ through 2″×16″ wood joist constructions, metal stud constructions, and t-bar ceiling constructions.

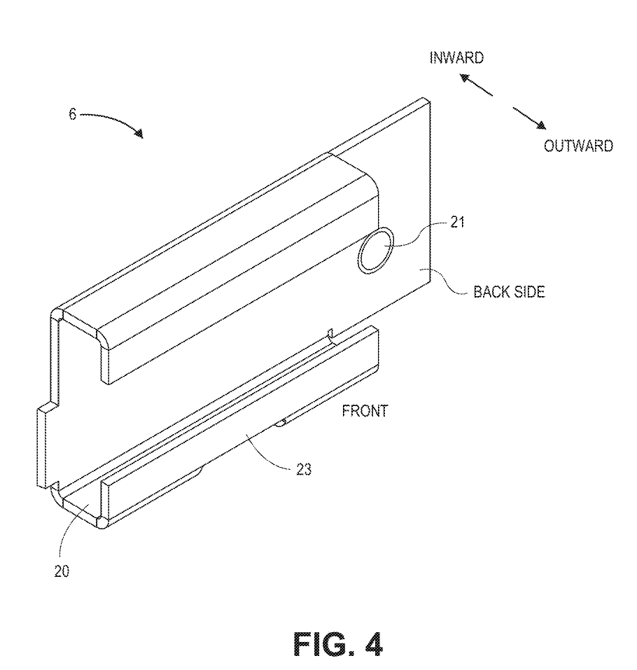

In one embodiment, the recessed lighting system 1 may include a set of hangar holders 6. The hangar holders 6 may be configured to slide or otherwise move along corresponding hangar bars 5. For example, FIG. 4 shows a perspective view of a hangar holder 6 according to one embodiment. As shown in FIG. 4, the hangar holder 6 may form a railing structure 20 to meet the dimensions of the hangar bars 5. Similar to the railing structure 17 of the outer arm elements 16B, the railing structure 20 of the hangar holders 6 may be formed by a set of guides. The guides may be bent pieces of the hangar holders 6 or tabs that are coupled to the hangar holders 6. As described above, the railing structure 20 of the hangar holder 6 allows the hangar holders 6 to slide along the hangar bars 5.

In one embodiment, the hangar holders 6 may include an attachment mechanism 21 for coupling with the junction box 2. The attachment mechanism 21 may be any mechanism that allows the junction box 2 to be removably connected to the hangar bars 5. For example, as shown in FIG. 1 and FIG. 4, the attachment mechanism 21 may be a hole that is to receive a screw 25 or bolt therein. However, in other embodiments, the attachment mechanism 21 may include resins, clips, and/or clamps that allow the hangar holders 6 to be coupled to the junction box 2. By being coupled to the hangar holders 6, the junction box 2, along with the light source module 7 and the driver 8 therein, may be moved across the hangar bars 5 to a desired location as shown in FIG. 5. Accordingly, during installation of the recessed lighting system 1, the hangar bars 5 may be installed inside a gap between beams within a structure by affixing the mounting blocks 19 to the beams, and then the junction box 2, along with the light source module 7 and the driver 8 therein, may be moved by the installer to a desired location along the hangar bars 5 and within the gap.

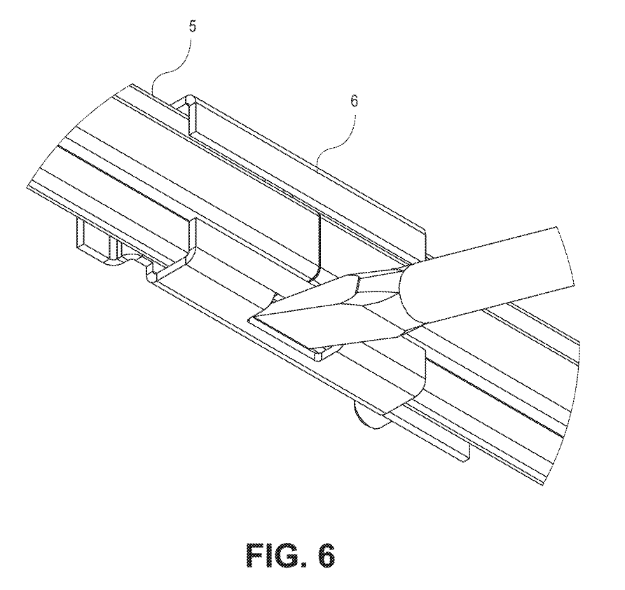

In one embodiment, the recessed lighting system 1 may include a hangar holder lock 23, which locks the hangar holder 6 at a certain position along the hangar bar 5. The hangar holder lock 23 may be any device or mechanism that locks or secures the hangar holder 6 at a certain position along the hangar bar 5. For example, in one embodiment, one or both of the hangar holder 6 may include a tab, which acts as the hangar holder lock 23. The tab may be bent (e.g., using a screwdriver as shown in FIG. 6) through an opening such that the tab is forced against its corresponding hangar bar 5, or alternatively a portion of the bar 5 is bent and forced against the holder 6, like a pinching action. This friction/tension caused by bending the tab or by bending the bar 5 locks or secures the hangar holder 6 in a desired position along the hangar bar 6.

Referring back to FIG. 1, in one embodiment, the junction box 2 may include a complimentary slot 22 to engage with the attachment mechanism 21 of the hangar holder 6 (FIG. 4). The slot 22 allows the junction box 2 to be coupled to the hangar holder 6 in one of a number of positions along the bar 5. In this case, the slot 22 is oriented parallel to an axis that is perpendicular to the hangar bars 5 (e.g., a Y-axis). For example, the junction box 2 may be moved along the axis Y as shown in FIG. 5 before being locked in a particular position. In this embodiment, the axis Y may be perpendicular as shown in FIG. 5 but more generally it may be not parallel to the longitudinal axis of the hangar bar 5. Accordingly, the junction box 2, along with the light source module 7 and the driver 8, may be moved and/or adjusted in another direction. This adjustment may assist in ensuring that the frontmost surface of the unified casting 3 that is attached inside the junction box 2 is flush or sufficiently close to the ceiling or wall during installation. In one embodiment, as shown in FIG. 1, the attachment mechanism 21 may form a pin for insertion into the slot 22. In this embodiment, the pin may be sized to slide along the length of the slot 22 and the pin may include a hole for receiving a screw or bolt such that the hangar holder 6 may be securely coupled to the junction box 2.

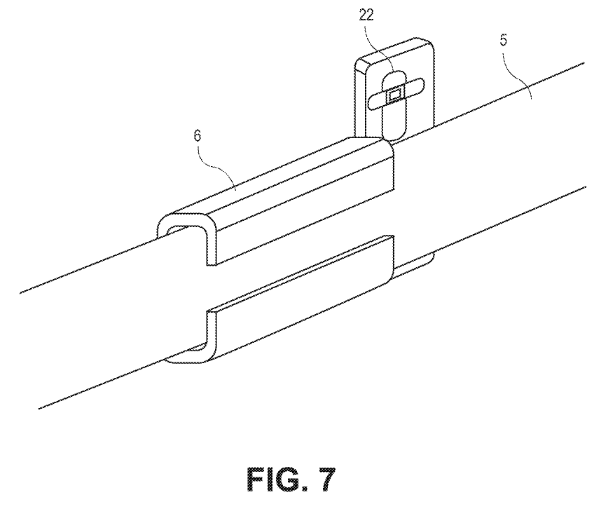

Although described as being part of the junction box 2, in some embodiments the slot 22 may be part of the hangar holder 6. For example, as shown in FIG. 7, the slot 22 is formed on the back side of the hangar holder 6 rather than in the sidewall of the junction box 2. In this embodiment, the attachment mechanism 21 may be moved to the junction box 2.

The locking of the junction box 2 in a position along the movement axis may be performed using any locking mechanism. In one embodiment, as seen in FIG. 1, the junction box 2 may be locked into a position along the axis Y by tightening a nut on a respective screw or bolt that links the attachment mechanism 21 and the slot 22. The nut may be accessible through the cavity 12 of the junction box 2, such that the junction box 2 may be easily locked at a particular position along the axis Y during installation of the recessed lighting system 1 inside a ceiling or wall of a structure.

As described above, traditional recessed lighting systems provide a separation between a driver and a light source module. This separation adds to the combined size of the recessed lighting system. In particular, a junction box and a can, which respectively house the driver and light source module in these traditional recessed lighting systems must be separately mounted on the hangar bars. This separate mounting requires additional hardware and bulk. Further, movement and/or adjustment of the light source module may be difficult in these recessed lighting systems as the combined junction box and driver are static

As described above, the hangar holders 6 described herein allow the junction box 2 to be moved in a direction parallel to a longitudinal axis of the hangar bars 5 and in a direction not parallel (e.g., perpendicular) to the hangar bars 5 (e.g., the axis Y). Accordingly, the junction box 2 may be moved to a preferred location between a set of joists or beams in a structure and at a desired height before the being locked into position using the mechanisms 21 and 22. The casting 3 is then positioned inside the box 2 as shown. By being configured such that the junction box 2, along with the light source module 7 and the driver 8 therein, is coupled to a unified set of moveable elements that assist in positioning the combined structure, the recessed lighting system 1 eliminates the added bulk and size of traditional recessed lighting systems. In particular, the recessed lighting system 1 allows adjustment of the position of the light source module 7 between joists or beams without the need for a compartment or can dedicated to housing the light source module 7 and a separate compartment dedicated to housing the driver 8. Instead, the light source module 7 may be housed along with the driver 8 in a shared junction box 2 that jointly moves these elements to a desired position. This compact design provides an affordable design by cutting the cost of raw materials and other components and reduces shipping costs by reducing bulk. Also, by having the driver 8 and the light source module 7 placed in the junction box 2, serviceability and replacement of the driver 8 will be easier to perform and more convenient. In contrast, traditional housings have the driver 8 mounted on the junction box 2 and contractors are forced to spend a significant amount of time removing parts to gain access to the junction box 2 and the driver 8.

While certain embodiments have been described and shown in the accompanying drawings, it is to be understood that such embodiments are merely illustrative of and not restrictive on the broad invention, and that the invention is not limited to the specific constructions and arrangements shown and described, since various other modifications may occur to those of ordinary skill in the art. The description is thus to be regarded as illustrative instead of limiting.

1. A recessed lighting installation assembly, comprising:
a junction box having a cavity to contain a lighting system together with electrical wires from an electrical system of a building for connection to the lighting system; and
a plurality of telescoping hangar bars coupled to the junction box to hold the junction box in a gap between a plurality of beams in the building, each telescoping hangar bar of the plurality of telescoping hangar bars being extendible and/or retractable to vary a length of each telescoping hangar bar between the plurality of beams to meet the gap between the plurality of beams,
wherein:
a position of the junction box is adjustable along the length of each telescoping hangar bar between the plurality of beams; and
the recessed lighting installation assembly does not include a can, separate from the junction box, to contain the lighting system.

2. The recessed lighting installation assembly of claim 1, wherein a shape of the junction box is at least one of a polyhedron, an ellipsoid, a cone, and a cylinder.

3. The recessed lighting installation assembly of claim 1, wherein the junction box is formed of at least one of:
at least one metal;
at least one polymer;
at least one metal alloy; and
at least one other heat insulating material.

4. The recessed lighting installation assembly of claim 1, wherein the junction box is a single gang box or a double gang box.

5. The compact recessed lighting system of claim 1, wherein the junction box includes at least one knockout to allow passage of the electrical wires from the electrical system of the building into the cavity of the junction box.

6. The recessed lighting installation assembly of claim 1, wherein the junction box includes one or more mounting tabs to align with one or more corresponding elements of the lighting system.

7. The recessed lighting installation assembly of claim 1, wherein the plurality of hangar bars is coupled to the junction box such that the junction box also is movable along an axis that is not parallel to the length of the plurality of hangar bars.

8. The recessed lighting installation assembly of claim 1, further comprising a plurality of hangar holders, each hangar holder of the plurality of hangar holders comprising:
a railing structure to hold one telescoping hangar bar of the plurality of telescoping hangar bars and allow the hangar holder to slide with respect to the length of the one telescoping hangar bar; and
an attachment mechanism to couple the hangar holder to the junction box and allow the junction box to be removably coupled to the one telescoping hangar bar.

9. The recessed lighting installation assembly of claim 8, wherein for each hangar holder, the attachment mechanism is coupled to the junction box such that the junction box is movable along an axis that is not parallel to the length of each hangar bar.

10. The recessed lighting installation assembly of claim 1, in combination with the lighting system disposed in the cavity of the junction box, wherein the lighting system comprises:
a casting containing a light source module; and
a driver including electronic circuitry to provide power to the light source module, the driver being electrically coupled within the cavity of the junction box to the electrical wires from the electrical system of the building.

11. A recessed lighting installation assembly, comprising:
a junction box having a cavity to contain a lighting system together with electrical wires from an electrical system of a building for connection to the lighting system, wherein:
a shape of the junction box is at least one of a polyhedron, an ellipsoid, a cone, and a cylinder;
the junction box is formed of at least one of:
at least one metal;
at least one polymer;
at least one metal alloy; and
at least one other heat insulating material; and
the junction box includes at least one knockout to allow passage of the electrical wires from the electrical system of the building into the cavity of the junction box;
a plurality of telescoping hangar bars coupled to the junction box to hold the junction box in a gap between a plurality of beams in the building, each telescoping hangar bar of the plurality of telescoping hangar bars comprising a pair of mounting blocks to mechanically couple the telescoping hangar bar to the plurality of beams, each telescoping hangar bar being extendible and/or retractable to vary a length of each telescoping hangar bar between the plurality of beams to meet the gap between the plurality of beams; and
a plurality of hangar holders, each hangar holder of the plurality of hangar holders comprising:
an attachment mechanism to couple the hangar holder to the junction box;
a railing structure to hold one telescoping hangar bar of the plurality of telescoping hangar bars and allow the hangar holder to slide with respect to the length of the one telescoping hangar bar, wherein a position of the junction box is adjustable along the length of the one telescoping hangar bar between the plurality of beams; and
a hangar holder lock to secure the hangar holder and the junction box at the position along the length of the one telescoping hangar bar.

12. The recessed lighting installation assembly of claim 11, wherein the recessed lighting installation assembly does not include a can, separate from the junction box, to contain the lighting system.

13. The recessed lighting installation assembly of claim 12, wherein for each hangar holder, the attachment mechanism is coupled to the junction box such that the junction box is movable along an axis that is not parallel to the length of each hangar bar.

14. The recessed lighting installation assembly of claim 13, wherein:
the junction box includes a plurality of mounting tabs to align with one or more corresponding elements of the lighting system; and
the one or more mounting tabs of the junction box include holes for receiving screws or bolts to couple the lighting system to the junction box.

15. The recessed lighting installation assembly of claim 14, in combination with the lighting system disposed in the cavity of the junction box and the electrical wires from the electrical system of the building, wherein the lighting system comprises:
a casting containing a light source module, the casting having the corresponding elements that align with the holes in the plurality of mounting tabs of the junction box; and
a driver including electronic circuitry to provide power to the light source module, the driver being electrically coupled within the cavity of the junction box to the electrical wires from the electrical system of the building.

16. The recessed lighting installation assembly of claim 15, wherein:
the electrical wires receive a voltage of at least 120 VAC from the electrical system of the building; and
the driver is electrically coupled within the cavity of the junction box to the electrical wires from the electrical system of the building via at least one of electrical caps and interlocking connectors.

17. A recessed lighting system, comprising:
a junction box having a sidewall that joins a top end, defines a bottom opening, and surrounds a cavity, wherein the cavity is configured to receive a light source module and a driver to power the light source module, wherein the junction box includes one or more mounting tabs positioned proximate to the bottom opening of the junction box to align with one or more corresponding elements of the light source module, wherein the shape of the junction box is at least one of a polyhedron, an ellipsoid, a cone, or a cylinder, wherein the sidewall of the junction box includes at least one knockout;
a plurality of hangar bar holders, each one of the plurality of hangar bar holders being moveably coupled to the junction box through a first attachment mechanism formed on each one of the plurality of hangar bar holders, wherein each first attachment mechanism is received by a corresponding one of a plurality of holes formed on the sidewall of the junction box, wherein each one of the plurality of hangar bar holders includes a hangar bar holder lock to secure each one of the hangar bar holders at a position along the corresponding one of the hangar bars;
a plurality of hangar bars to hold the junction box in a gap between a plurality of beams in a building, each one of the plurality of hangar bars being coupled to a corresponding one of the plurality of hangar bar holders via a railing structure disposed on each one of the hangar bar holders such that each one of the hangar bar holders slides along a corresponding one of the hangar bars; and
a pair of mounting blocks disposed on each one of the plurality of hangar bars, wherein each mounting block includes a second attachment mechanism to couple the junction box to the plurality of beams in the building.

18. The recessed lighting system of claim 17, further comprising:
a unified casting having contained therein the light source module, the unified casting having the one or more corresponding elements that align with the one or more mounting tabs of the junction box, wherein the unified casting is at least partially positioned inside the cavity of the junction box such that the light source module is contained within the cavity of the junction box; and
the driver to power the light source module, the driver being positioned inside the cavity of the junction box.

19. The recessed lighting system of claim 18, wherein the light source module is a light emitting diode (LED) module.

20. The recessed lighting system of claim 18, further comprising:
a trim coupled to the unified casting to cover a hole in a wall or ceiling in which the compact recessed lighting system is placed.
